(19) United States
(12) Patent Application Publication
(10) Pub. No.: US 2017/0220934 A1
(43) Pub. Date: Aug. 3, 2017

(54) MEMBER FEATURE SETS, DISCUSSION FEATURE SETS AND TRAINED COEFFICIENTS FOR RECOMMENDING RELEVANT DISCUSSIONS

(71) Applicant: LinkedIn Corporation, Mountain View, CA (US)

(72) Inventors: Jeffrey Douglas Gee, San Francisco, CA (US); Luke John Duncan, San Francisco, CA (US); Heloise Hwawen Logan, Sunnyvale, CA (US); Jeffrey Chow, South San Francisco, CA (US); Alexandre Patry, Pleasanton, CA (US); Prachi Gupta, San Mateo, CA (US); Minal Mehta, Belmont, CA (US)

(21) Appl. No.: 15/009,693

(22) Filed: Jan. 28, 2016

(51) Int. Cl. G06N 5/04; G06N 99/00; H04L 12/58

(52) U.S. Cl. CPC G06N 5/04; H04L 51/32; G06N 99/005

(57) ABSTRACT

A system, a machine-readable storage medium storing instructions, and a computer-implemented method are described herein to a Discussion Relevance Engine that filters a plurality of discussions in a social network to identify a discussion pool. The Discussion Relevance Engine identifies a plurality of eligible discussions in the discussion pool, wherein each eligible discussion corresponds to a respective social network member group to which a target member account has previously subscribed. The Discussion Relevance Engine calculates, for each eligible discussion, a relevance score predictive of a relevance of the eligible discussion to the target member account. The Discussion Relevance Engine recommends at least one of the eligible discussions to the target member account based at least in part on the calculated relevance scores.

### TECHNICAL FIELD

The present disclosure generally relates to data processing systems. More specifically, the present disclosure relates to methods, systems and computer program products for determining relevant content based on trained data and predetermined feature sets.

### BACKGROUND

A social networking service is a computer- or web-based application that enables users to establish links or connections with persons for the purpose of sharing information with one another. Some social networking services aim to enable friends and family to communicate with one another, while others are specifically directed to business users with a goal of enabling the sharing of business information. For purposes of the present disclosure, the terms “social network” and “social networking service” are used in a broad sense and are meant to encompass services aimed at connecting friends and family (often referred to simply as “social networks”), as well as services that are specifically directed to enabling business people to connect and share business information (also commonly referred to as “social networks” but sometimes referred to as “business networks”).

With many social networking services, members are prompted to provide a variety of personal information, which may be displayed in a member's personal web page. Such information is commonly referred to as personal profile information, or simply “profile information”, and when shown collectively, it is commonly referred to as a member's profile. For example, with some of the many social networking services in use today, the personal information that is commonly requested and displayed includes a member's age, gender, interests, contact information, home town, address, the name of the member's spouse and/or family members, and so forth. With certain social networking services, such as some business networking services, a member's personal information may include information commonly included in a professional resume or curriculum vitae, such as information about a person's education, employment history, skills, professional organizations, and so on. With some social networking services, a member's profile may be viewable to the public by default, or alternatively, the member may specify that only some portion of the profile is to be public by default. Accordingly, many social networking services serve as a sort of directory of people to be searched and browsed.

### DESCRIPTION OF THE DRAWINGS

Some embodiments are illustrated by way of example and not limitation in the figures of the accompanying drawings in which:

FIG. 1 is a block diagram illustrating a client-server system, in accordance with an example embodiment;

FIG. 2 is a block diagram showing functional components of a professional social network within a networked system, in accordance with an example embodiment;

FIG. 3 is a flowchart illustrating a method of filtering a plurality of discussions to identify a discussion pool, according to embodiments described herein.

FIG. 4 is a flowchart illustrating a method of identifying a plurality of eligible discussions in a discussion pool, according to embodiments described herein.

FIG. 5 is a flowchart illustrating a method of calculating relevance scores, according to embodiments described herein.

FIG. 6 is a block diagram showing a recommendation of a discussion to a target account member based on a calculated relevance score, according to embodiments described herein.

FIG. 7 is a block diagram showing example components of a Discussion Relevance Engine according to some embodiments;

FIG. 8 is a block diagram of an example computer system on which methodologies described herein may be executed, in accordance with an example embodiment.

### DETAILED DESCRIPTION

The present disclosure describes methods and systems for predicting a relevance of one or more discussions within a professional social networking service (also referred to herein as a “professional social network” and “social network”) to a target member account. In the following description, for purposes of explanation, numerous specific details are set forth in order to provide a thorough understanding of the various aspects of different embodiments of the present invention. It will be evident, however, to one skilled in the art, that the present invention may be practiced without all of the specific details.

A system, a machine-readable storage medium storing instructions, and a computer-implemented method are described herein and directed to a Discussion Relevance Engine for filtering a plurality of discussions in a social network to identify a discussion pool. The Discussion Relevance Engine identifies a plurality of eligible discussions in the discussion pool, wherein each eligible discussion corresponds to a respective social network member group to which a target member account has previously subscribed. The Discussion Relevance Engine calculates, for each eligible discussion, a relevance score predictive of a relevance of the eligible discussion to the target member account. The Discussion Relevance Engine recommends at least one of the eligible discussions to the target member account based at least in part on the calculated relevance scores.

In example embodiments, the Discussion Relevance Engine utilizes a machine learning model for predicting whether a given discussion that is actively occurring in a social network is relevant to a target member account. For example, a discussion can be a thread of comments received from various member accounts of the social network. A discussion further includes attributes such as ratings, likes and views. The Discussion Relevance Engine builds the model based on training data. The training data includes interactions of various member accounts with regard to various discussions. For example, such interactions comprise social network activity such as posting a comment in the discussion, “liking” a discussion, forwarding (i.e. sharing) a discussion to another member account, authoring a discussion. For purposes of the training data, social network activity can also be a decision by a given member account to not join a discussion. The training data also includes profile attributes of the various member accounts who interact with one or more discussions and/or are authors of one or more discussions. For example, such member account profile attributes include gender, location, industry type, education level, one or more job titles, one or more job descriptions, skills, and endorsements.

The training data is utilized to identify which matched attribute pairs between a given account member and a given group are germane in predicting the relevance of that group to the given account member. Those attributes that are considered germane to predicting relevance are identified as features of the model. The Discussion Relevance Engine applies logistic regression algorithms to learn coefficient weights for each particular matched attribute pair. In other words, the Discussion Relevance Engine utilizes logistic regression algorithms to calculate a first learned updateable coefficient weight for an “Industry” feature being a match between a given account member's Education attribute and a group's Education attribute. The Discussion Relevance Engine further utilizes logistic regression algorithms to calculate a second learned updateable coefficient weight for an “Skills” feature being a match between a given account member's Employer attribute and a group's Employer attribute. Each learned coefficient weight reflects a priority weight that the match is given when calculating the relevance score.

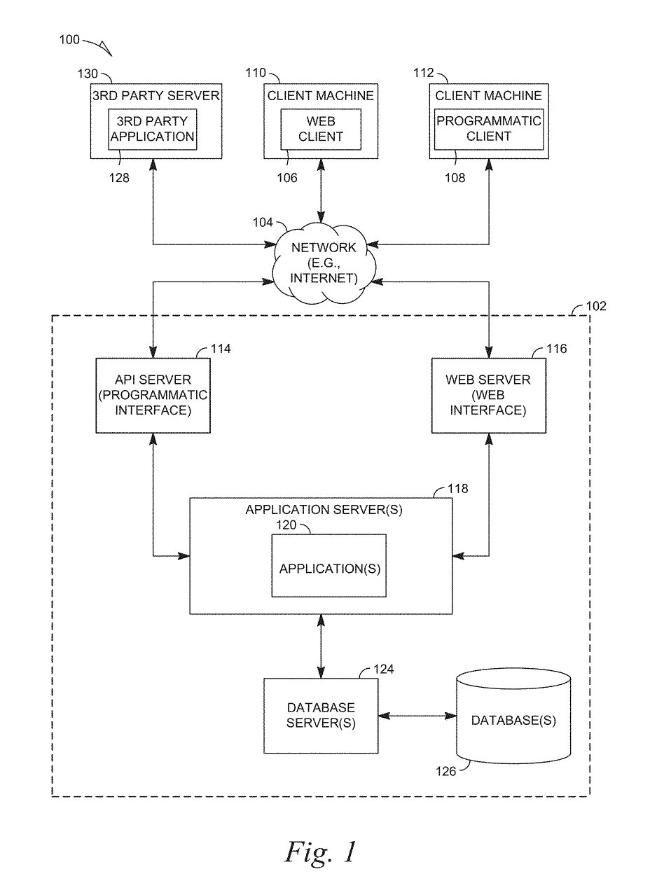

Turning now to FIG. 1, FIG. 1 is a block diagram illustrating a client-server system, in accordance with an example embodiment. A networked system 102 provides server-side functionality via a network 104 (e.g., the Internet or Wide Area Network (WAN)) to one or more clients. FIG. 1 illustrates, for example, a web client 106 (e.g., a browser) and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more applications 120. The application servers 118 are, in turn, shown to be coupled to one or more database servers 124 that facilitate access to one or more databases 126. While the applications 120 are shown in FIG. 1 to form part of the networked system 102, it will be appreciated that, in alternative embodiments, the applications 120 may form part of a service that is separate and distinct from the networked system 102.

Further, while the system 100 shown in FIG. 1 employs a client-server architecture, the present disclosure is of course not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the applications 120 via the programmatic interface provided by the API server 114.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more functions that are supported by the relevant applications of the networked system 102. In some embodiments, the networked system 102 may comprise functional components of a professional social network.

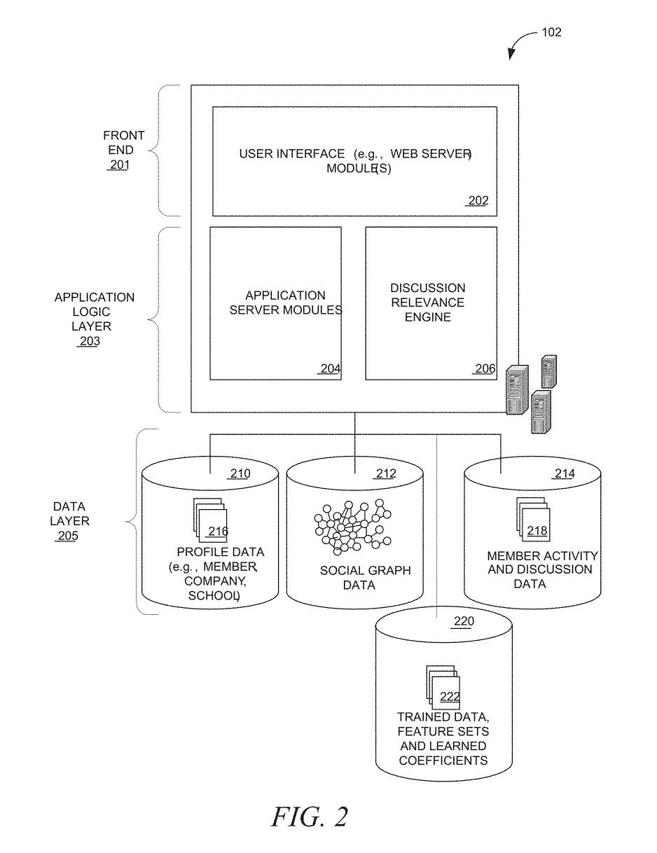

FIG. 2 is a block diagram showing functional components of a professional social network within the networked system 102, in accordance with an example embodiment.

As shown in FIG. 2, the professional social network may be based on a three-tiered architecture, consisting of a front-end layer 201, an application logic layer 203, and a data layer 205. In some embodiments, the modules, systems, and/or engines shown in FIG. 2 represent a set of executable software instructions and the corresponding hardware (e.g., memory and processor) for executing the instructions. To avoid obscuring the inventive subject matter with unnecessary detail, various functional modules and engines that are not germane to conveying an understanding of the inventive subject matter have been omitted from FIG. 2. However, one skilled in the art will readily recognize that various additional functional modules and engines may be used with a professional social network, such as that illustrated in FIG. 2, to facilitate additional functionality that is not specifically described herein. Furthermore, the various functional modules and engines depicted in FIG. 2 may reside on a single server computer, or may be distributed across several server computers in various arrangements. Moreover, although a professional social network is depicted in FIG. 2 as a three-tiered architecture, the inventive subject matter is by no means limited to such architecture. It is contemplated that other types of architecture are within the scope of the present disclosure.

As shown in FIG. 2, in some embodiments, the front-end layer 201 comprises a user interface module (e.g., a web server) 202, which receives requests and inputs from various client-computing devices, and communicates appropriate responses to the requesting client devices. For example, the user interface module(s) 202 may receive requests in the form of Hypertext Transport Protocol (HTTP) requests, or other web-based, application programming interface (API) requests.

In some embodiments, the application logic layer 203 includes various application server modules 204, which, in conjunction with the user interface module(s) 202, generates various user interfaces (e.g., web pages) with data retrieved from various data sources in the data layer 205. In some embodiments, individual application server modules 204 are used to implement the functionality associated with various services and features of the professional social network. For instance, the ability of an organization to establish a presence in a social graph of the social network service, including the ability to establish a customized web page on behalf of an organization, and to publish messages or status updates on behalf of an organization, may be services implemented in independent application server modules 204. Similarly, a variety of other applications or services that are made available to members of the social network service may be embodied in their own application server modules 204.

As shown in FIG. 2, the data layer 205 may include several databases, such as a database 210 for storing profile data 216, including both member profile attribute data as well as profile attribute data for various organizations. Consistent with some embodiments, when a person initially registers to become a member of the professional social network, the person will be prompted to provide some profile attribute data such as, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information may be stored, for example, in the database 210. Similarly, when a representative of an organization initially registers the organization with the professional social network the representative may be prompted to provide certain information about the organization. This information may be stored, for example, in the database 210, or another database (not shown). With some embodiments, the profile data 216 may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or a seniority level within a particular company. With some embodiments, importing or otherwise accessing data from one or more externally hosted data sources may enhance profile data 216 for both members and organizations. For instance, with companies in particular, financial data may be imported from one or more external data sources, and made part of a company's profile.

The profile data 216 may also include information regarding settings for members of the professional social network. These settings may comprise various categories, including, but not limited to, privacy and communications. Each category may have its own set of settings that a member may control.

Once registered, a member may invite other members, or be invited by other members, to connect via the professional social network. A “connection” may require a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed or content stream. In any case, the various associations and relationships that the members establish with other members, or with other entities and objects, may be stored and maintained as social graph data within a social graph database 212.

The professional social network may provide a broad range of other applications and services that allow members the opportunity to share and receive information, often customized to the interests of the member. For example, with some embodiments, the professional social network may include a photo sharing application that allows members to upload and share photos with other members. With some embodiments, members may be able to self-organize into groups, or interest groups, organized around a subject matter or topic of interest. With some embodiments, the professional social network may host various job listings providing details of job openings with various organizations.

As members interact with the various applications, services and content made available via the professional social network, the members' behaviour (e.g., content viewed, links or member-interest buttons selected, etc.) may be monitored and information 218 concerning the member's activities and behaviour may be stored, for example, as indicated in FIG. 2, by the database 214. This information 218 may be used to classify the member as being in various categories and may be further considered as an attribute or feature of the member. For example, if the member performs frequent searches of job listings, thereby exhibiting behaviour indicating that the member is a likely job seeker, this information 218 can be used to classify the member as being a job seeker. This classification can then be used as a member profile attribute for purposes of enabling others to target the member for receiving messages, status updates and/or a list of ranked premium and free job postings. The data layer 205 further includes a machine learning data repository 220 which includes training data, predetermined feature sets and one or more learned updateable coefficients.

In some embodiments, the professional social network provides an application programming interface (API) module via which third-party applications can access various services and data provided by the professional social network. For example, using an API, a third-party application may provide a user interface and logic that enables an authorized representative of an organization to publish messages from a third-party application to a content hosting platform of the professional social network that facilitates presentation of activity or content streams maintained and presented by the professional social network. Such third-party applications may be browser-based applications, or may be operating system-specific. In particular, some third-party applications may reside and execute on one or more mobile devices (e.g., a smartphone, or tablet computing devices) having a mobile operating system.

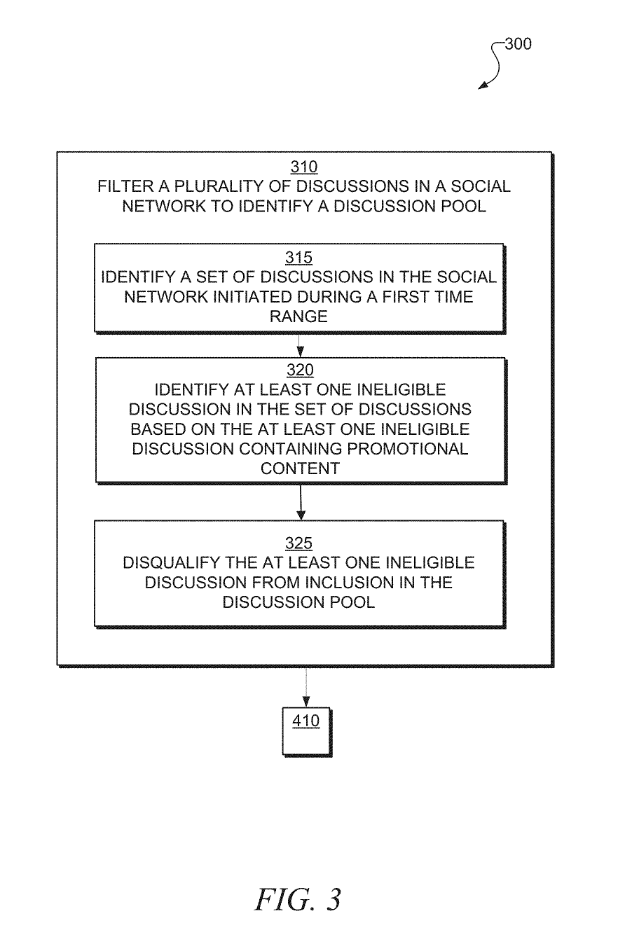

The data in the data layer 205 may be accessed, used, and adjusted by the Discussion Relevance Engine 206 as will be described in more detail below in conjunction with FIGS. 3-7. Although the Discussion Relevance Engine 206 is referred to herein as being used in the context of a professional social network, it is contemplated that it may also be employed in the context of any website or online services, including, but not limited to, content sharing sites (e.g., photo- or video-sharing sites) and any other online services that allow users to have a profile and present themselves or content to other users. Additionally, although features of the present disclosure are referred to herein as being used or presented in the context of a web page, it is contemplated that any user interface view (e.g., a user interface on a mobile device or on desktop software) is within the scope of the present disclosure. In various example embodiments, the Discussion Relevance Engine 206 can be implemented at one or more application servers 118 as illustrated in FIG. 1.

FIG. 3 is a flowchart illustrating a method 300 of filtering a plurality of discussions to identify a discussion pool, according to embodiments described herein.

At operation 310, the Discussion Relevance Engine 206 filters a plurality of discussions in a social network to identify a discussion pool. In order to filter the discussion pool, at operation 315, the Discussion Relevance Engine 206 identifies a set of discussions in the social network initiated during a first time range. For example, the Discussion Relevance Engine 206 identifies discussions identifies a set of discussion that includes all new discussions that were initiated during the last month, the last week or the past 24 hours. In another example, the Discussion Relevance Engine 206 identifies a set of discussions that includes all new discussions that have been initiated since the last time the Discussion Relevance Engine 206 filtered the discussion pool.

At operation 320, the Discussion Relevance Engine 206 identifies at least one ineligible discussion in the set of discussions based on the at least one ineligible discussion containing promotional content. For example, the Discussion Relevance Engine 206 analyses each discussion in the set of discussion to identify one or more keywords flagged as being representative of advertising content. A discussion with flagged advertising content can be identified as being ineligible due to the advertising content being a particular type of advertising content or if the advertising content includes a predetermined amount of keywords on a flagged keywords list.

At operation 325, the Discussion Relevance Engine 206 disqualifies the at least one ineligible discussion from inclusion in the discussion pool. For example, if the Discussion Relevance Engine 206 determines that a particular discussion has a number of flagged keywords that meets a keyword threshold number, the Discussion Relevance Engine 206 disqualifies that particular discussion from being eligible for being a discussion in the discussion pool that can be recommended to a member account. The remaining discussions in the set of discussions are included in the discussion pool.

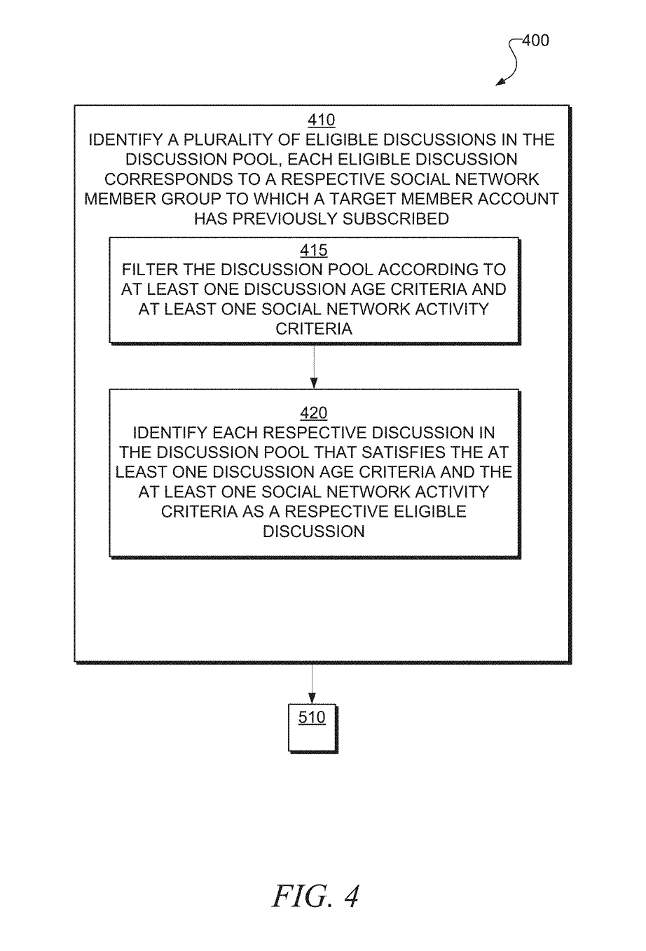

FIG. 4 is a flowchart illustrating a method 400 of identifying a plurality of eligible discussions in a discussion pool, according to embodiments described herein.

At operation 410, the Discussion Relevance Engine 206 identifies a plurality of eligible discussions in the discussion pool, wherein each eligible discussion corresponds to a respective social network member group to which a target member account has previously subscribed. For example, each discussion occurs within the context of a group in the social network. Each group has one or more member accounts that have subscribed to the group. For a target member account for whom the Discussion Relevance Engine 206 is identifying one or more discussion recommendations, the Discussion Relevance Engine 206 further filters the discussion pool to such that all discussions in the discussion pool are occurring in groups to which the target member account is a subscriber.

At operation 415, the Discussion Relevance Engine 206 filters the discussion pool according to at least one discussion age criteria and at least one social network activity criteria. In addition to considering discussions in groups to which the target member account is subscribed, the Discussion Relevance Engine 206 filters the discussion pool based on, as a non-limiting example, discussion age criteria of discussions created in the past 24 hours, the last week, the last month, the last year, etc.

The Discussion Relevance Engine 206 filters the discussion pool based on how an amount of social network activity meeting a social network activity threshold. For example, the Discussion Relevance Engine 206 calculates an activity score based on a number of views, a number of likes, a number of shares, a number of comments of a particular discussion. In an example embodiment, such scoring may prioritize the number comments over the number of views and may prioritize the number of shares over the number of likes.

At operation 420, the Discussion Relevance Engine 206 identifies each respective discussion in the discussion pool that satisfies the at least one discussion age criteria and the at least one social network activity criteria as a respective eligible discussion. For example, if the particular discussion has an activity score that meets the social network activity threshold or meets the discussion age threshold, then the Discussion Relevance Engine 206 does not remove the particular discussion from the discussion pool.

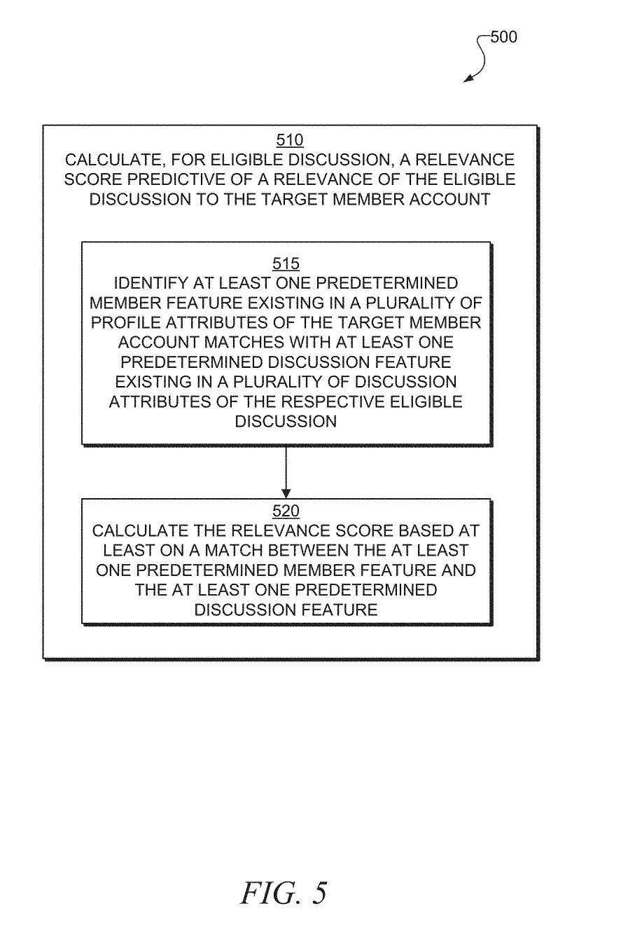

FIG. 5 is a flowchart illustrating a method 500 of calculating relevance scores, according to embodiments described herein.

At operation 510, the Discussion Relevance Engine 206 calculates, for each eligible discussion, a relevance score predictive of a relevance of the eligible discussion to the target member account. In order to calculate the relevance score, at operation 515, the Discussion Relevance Engine 206 identifies at least one predetermined member feature existing in a plurality of profile attributes of the target member account matches with at least one predetermined discussion feature existing in a plurality of discussion attributes of the respective eligible discussion.

According to one example embodiment, the Discussion Relevance Engine 206 identifies matches between topic features of a target account and an eligible discussion. The Discussion Relevance Engine 206 applies Latent Dirichlet allocation (LDA) scoring to calculate a first topic score of the text of the target member account's profile and a second topic score of the text of the eligible discussion. In another example, Discussion Relevance Engine 206 applies LDA scoring to calculate a first topic score of the text of a discussion in which the target member account previously posted a comment and a second topic score of the text of the eligible discussion. In another example, Discussion Relevance Engine 206 applies LDA scoring to calculate a first topic score of the text of the target member account's profile and a second topic score of the text of the profile of the member account who is the author of the eligible discussion. An author is a member account who initiated the eligible discussion or who created content upon which the eligible discussion is based.

At operation 520, the Discussion Relevance Engine 206 calculates the relevance score based at least on a match between the at least one predetermined member feature and the at least one predetermined discussion feature. With regard to topic scores, the Discussion Relevance Engine 206 compares the first and second topic scores to determine whether they both fall within a topic score range. If both the first and second topic scores fall within a topic score range, the Discussion Relevance Engine 206 determines there is a match between the first and second topic scores.

Upon determining the match, the Discussion Relevance Engine 206 calculates the product (or cross product) of both the first and second topic scores. The Discussion Relevance Engine 206 further identifies an updateable learned coefficient assigned to the match and further calculates the relevance score based at least on the updateable learned coefficient. For example, a first updateable learned coefficient is assigned to a first matching feature pair. A first matching feature pair can be a match between the text of the target member account's profile and the text of the eligible discussion. A second matching feature pair can be a match between the text of a discussion in which the target member account previously posted a comment and text of the eligible discussion. A second updateable learned coefficient is assigned to the second matching feature pair. A third matching feature pair can be a match between the text of the target member account's profile and the text of the profile of the member account who is the author of the eligible discussion. A third updateable learned coefficient is assigned to the third matching feature pair. The first, second and third updateable learned coefficient each have a different value, thereby signifying that one matching feature pair is more predictive of a discussion's relevance that a different matching feature pair.

As an example, for the first matching feature pair, the Discussion Relevance Engine 206 calculates a relevance score of an eligible discussion based at least on a result of the following: {first updateable learned coefficient*(Product of [LDA Score of text of profile of target member account] and [LDA Score of text of eligible discussion])}+{third updateable learned coefficient*(Product of [LDA Score of text of profile of target member account] and [LDA Score of text of the profile of the author member account])}. In this example, the second matching feature pair is not included in the scoring due to a lack of a match. If the relevance score meets a threshold score, the Discussion Relevance Engine 206 sends a notification to the target member account. The notification comprises a recommendation to the target member account to join the discussion.

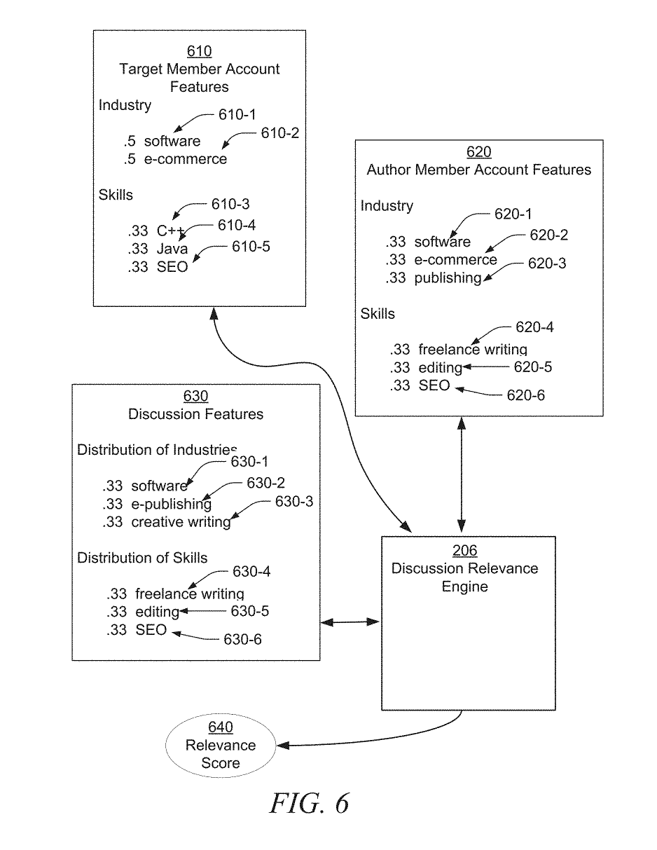

FIG. 6 is a block diagram showing a recommendation of a discussion to a target account member based on a calculated relevance score, according to embodiments described herein.

Feature sets for accounts and discussions are pre-defined. As illustrated in FIG. 6, the feature set includes an industry attribute and a skill attribute. The features 610 of the target member account has two industries 610-1, 610-2 (“software” and “e-commerce”). Since the target member account has two distinct industry features, the value for both of the particular account's industry features is both 0.5. The target member account has three skills (“C++”, “Java” and “SEO”). Since the target member account has three distinct skills features, the value for each of the target member account's skills features is 0.33.

The features 620 of the author member account has three industries 620-1, 620-2, 620-3 (“software”, “e-commerce” and “publishing”). Since the author member account has three distinct industry features, the value for each of the author member account's industry features is 0.33. The author member account has three skills 620-4, 620-5, 620-6 (“freelance writing”, “editing” and “SEO”). Since the author member account has three distinct skills features, the value for each of author member account's skills features is 0.33.

An eligible discussion has been viewed, commented on, shared by and rated by various member accounts. The features 630 of the eligible discussion are based on the distribution of the features of such various member accounts. The value for the eligible discussion's “software” industry feature 630-1 is 0.33 because 33% of various members who have interacted with the eligible discussion are in the “e-software” industry. The value for the eligible discussion's “e-publishing” industry feature is 0.33 because 33% of various members who have interacted with the eligible discussion are in the “e-publishing” industry. The value for the eligible discussion's “creative writing” industry feature is 0.33 because 33% of various members who have interacted with the eligible discussion are in the “creative writing” industry.

The value for the eligible discussion's “freelance writing” skills feature 630-4 is 0.33 because 33% of various members who have interacted with the eligible discussion have the “freelance writing” skill. The value for the eligible discussion's “editing” skills feature 630-5 is 0.33 because 33% of various members who have interacted with the eligible discussion have the “editing” skill. The value for the eligible discussion's “SEO” skills feature 630-6 is 0.33 because 33% of various members who have interacted with the eligible discussion have the “SEO” skill.

The Discussion Relevance Engine 206 identifies matches between the target member account features 610 and the author member account features 620. For example, there are two industry feature matches for “software” 610-1, 620-1 and “e-commerce” 610-2, 620-2. Also, there is one skills feature match for “SEO” 610-5, 620-5.

The Discussion Relevance Engine 206 calculates the product of the values of the matching features between the target member account and the author member account. Each type of feature match has a corresponding learned coefficient (hereinafter “Coeff”). As previously discussed, each type of feature match has a distinct learned updateable coefficient that represents how much the existence of the feature match between a given target member account and an eligible discussion predicts that the eligible discussion is relevant to the given target member account.

For the “software” industry feature match 610-1, 620-1, the Discussion Relevance Engine 206 utilizes the product of 0.5 and 0.33. The Discussion Relevance Engine 206 calculates that A=Coeff for “software industry match between member accounts”*[product of 0.5 and 0.33].

For the “e-commerce” industry feature match 610-2, 620-2, the Discussion Relevance Engine 206 utilizes the product of 0.5 and 0.33. The Discussion Relevance Engine 206 calculates that B=Coeff for “e-commerce industry match” *[product of 0.5 and 0.33].

For the “SEO” skills feature match 610-5, 620-6, the Discussion Relevance Engine 206 utilizes the product of 0.33 and 0.33. The Discussion Relevance Engine 206 calculates that C=Coeff for “SEO skills match between member accounts” *[product of 0.33 and 0.33]. The relevance score 640 is based at least in part on A+B+C.

The Discussion Relevance Engine 206 calculates the product of the values of the matching features between the target member account and the discussion. For the “software” industry feature match 610-1, 630-1, the Discussion Relevance Engine 206 utilizes the product of 0.5 and 0.33. The Discussion Relevance Engine 206 calculates that D=Coeff for “software industry match between member account and discussion” *[product of 0.5 and 0.33].

For the “SEO” skills feature match 610-5, 630-6, the Discussion Relevance Engine 206 utilizes the product of 0.33 and 0.33. The Discussion Relevance Engine 206 calculates that E=Coeffor “SEO skills match between member account and discussion” *[product of 0.33 and 0.33]. The relevance score 640 is based at least in part on A+B+C+D+E. If the relevance score 640 meets a threshold score, the Discussion Relevance Engine 206 recommends the eligible discussion with the features 630 to the target member account.

It is understood that various features can be predetermined as predicting a relevance of a discussion to a given target member account. That is, some shared attributes between a target member account, discussion author account and/or a discussion are identified as being germane in predicting relevance of the discussion to the target member account. Such shared attributes are part of the feature set. However, some other shared attributes are not germane in predicting relevance. These other shared attributes are not included in the feature set.

As an example, Topic Distribution can be included in the feature set. The Discussion Relevance Engine 206 applies Latent Dirichlet allocation (LDA) to determine a distribution of topics of the target member account's profile and the author member account's profile. The Discussion Relevance Engine 206 creates a Topic feature vector for both the target member account and the author member account. Each Topic feature vector reflects a distribution of topics. For example, the each member account profile has a topic distribution value for Topic 1 (“T1”), Topic 2 (“T2”), Topic 3 (“T3”), Topic 4 (“T4”) . . . Topic in (“Tn”).

Topic distribution values for the target member account can be T1=0.33, T2=0.33, T4=0. A Topic feature vector for the target member account is [0.33, 0.33, 0.33, 0]. Topic distribution values for the target member account can be T1=0.25, T2=0.25, T3−0.25, T4=0.25. A Topic feature vector for the author member account is [0.25, 0.25, 0.25, 25]. The Discussion Relevance Engine 206 calculates a dot product of these topic feature vectors and multiplies the result with an updated learned coefficient predetermined for the Topic Distribution. The Discussion Relevance Engine 206 includes the result of multiplying the result with the updated learned coefficient in calculating a relevance score that predicts a relevance of the author member account's discussion to the target member account.

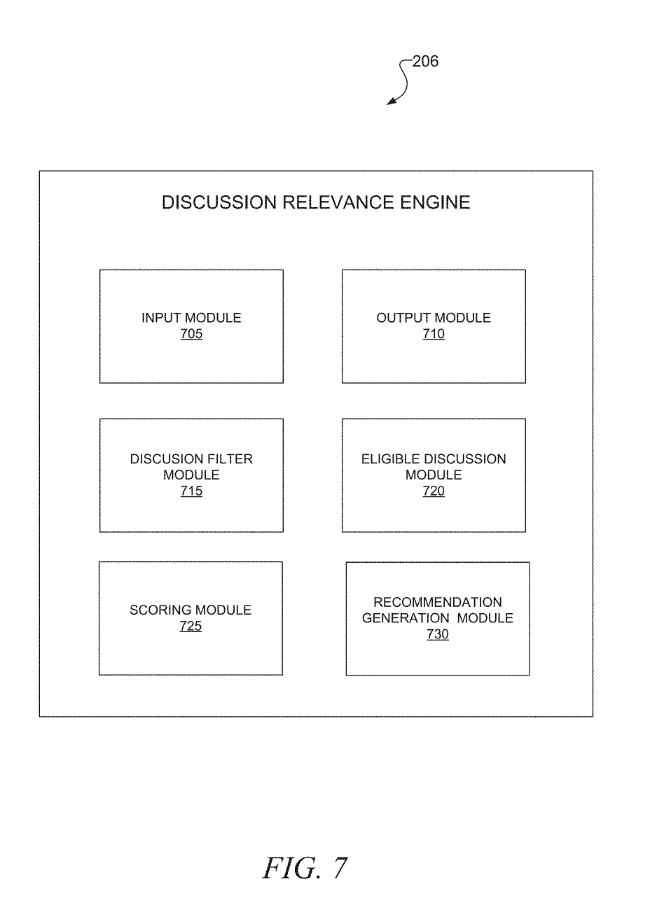

FIG. 7 is a block diagram showing example components of a Discussion Relevance Engine, according to some embodiments.

The input module 705 is a hardware-implemented module that controls, manages and stores information related to any inputs from one or more components of system 102 as illustrated in FIG. 1 and FIG. 2. In various embodiments, the inputs include one or more member accounts, one or more discussions, one or more feature set and one or more learned coefficients as described herein.

The output module 710 is a hardware-implemented module that controls, manages and stores information related to sending a recommendation of one or more eligible discussions to a target member account.

The discussion filter module 715 is a hardware implemented module which manages, controls, stores, and accesses information related to filtering a discussion pool as described herein.

The eligible discussion module 720 is a hardware-implemented module which manages, controls, stores, and accesses information related to identifying one or more eligible discussions as described herein.

The scoring module 725 is a hardware-implemented module which manages, controls, stores, and accesses information related to calculating one or more relevance scores as described herein.

The recommendation generation module 730 is a hardware-implemented module which manages, controls, stores, and accesses information related to generating a recommendation or one or more eligible discussions as described herein.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation, and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs)).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

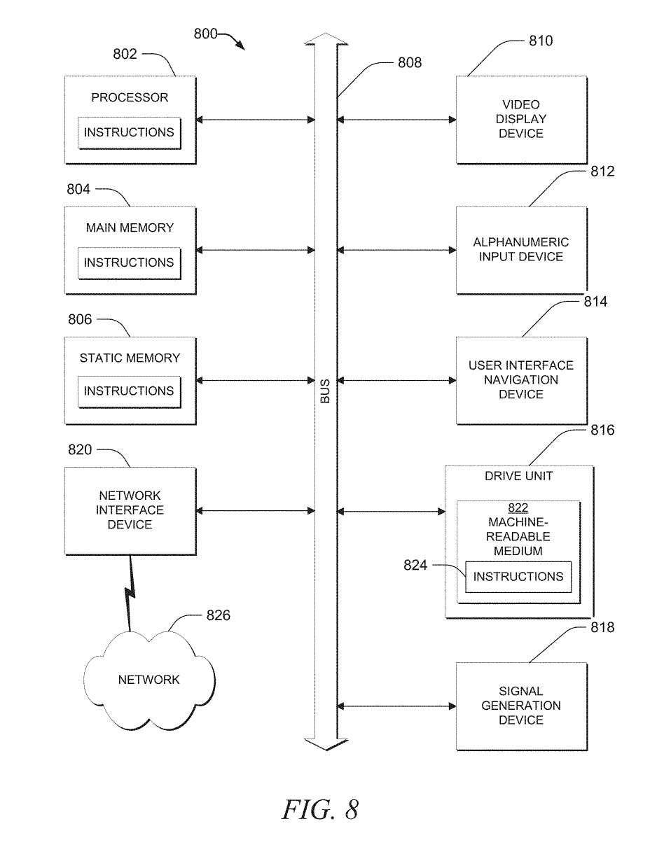

FIG. 8 is a block diagram of a machine in the example form of a computer system 800 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Example computer system 800 includes a processor 802 (e.g., a central processing unit (CPU), a graphics processing unit (GPU) or both), a main memory 804, and a static memory 806, which communicate with each other via a bus 808. Computer system 800 may further include a video display device 810 (e.g., a liquid crystal display (LCD) or a cathode ray tube (CRT)). Computer system 800 also includes an alphanumeric input device 812 (e.g., a keyboard), a user interface (UI) navigation device 814 (e.g., a mouse or touch sensitive display), a disk drive unit 816, a signal generation device 818 (e.g., a speaker) and a network interface device 820.

Disk drive unit 816 includes a machine-readable medium 822 on which is stored one or more sets of instructions and data structures (e.g., software) 824 embodying or utilized by any one or more of the methodologies or functions described herein. Instructions 824 may also reside, completely or at least partially, within main memory 804, within static memory 806, and/or within processor 802 during execution thereof by computer system 800, main memory 804 and processor 802 also constituting machine-readable media.

While machine-readable medium 822 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present technology, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

Instructions 824 may further be transmitted or received over a communications network 826 using a transmission medium. Instructions 824 may be transmitted using network interface device 820 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMAX networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the technology. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer system comprising:
a processor;
a memory device holding an instruction set executable on the processor to cause the computer system to perform operations comprising:
filtering a plurality of discussions in a social network to identify a discussion pool;
identifying a plurality of eligible discussions in the discussion pool, wherein each eligible discussion corresponds to a respective social network member group to which a target member account has previously subscribed;
calculating, for each eligible discussion, a relevance score predictive of a relevance of the eligible discussion to the target member account; and
recommending at least one of the eligible discussions to the target member account based at least in part on the calculated relevance scores.

2. The computer system of claim 1, wherein filtering a plurality of discussions in a social network to identify a discussion pool comprises:
identifying a set of discussions in the social network initiated during a first time range;
identifying at least one ineligible discussion in the set of discussions based on the at least one ineligible discussion containing promotional content; and
disqualifying the at least one ineligible discussion from inclusion in the discussion pool.

3. The computer system of claim 1, wherein identifying a plurality of eligible discussions in the discussion pool comprises:
filtering the discussion pool according to at least one of: at least one discussion age criteria and at least one social network activity criteria; and
identifying each respective discussion in the discussion pool that satisfies the at least one discussion age criteria and the at least one social network activity criteria as a respective eligible discussion.

4. The computer system of claim 1, wherein calculating, for each eligible discussion, a relevance score predictive of a relevance of the eligible discussion to the target member account comprises:
identifying at least one predetermined member feature existing in a plurality of profile attributes of the target member account matches at least one predetermined discussion feature existing in a plurality of discussion attributes of the respective eligible discussion; and
calculating, for the respective eligible discussion, the relevance score based at least on a match between the at least one predetermined member feature and the at least one predetermined discussion feature.

5. The computer system of claim 4, wherein calculating, for each eligible discussion, a relevance score predictive of a relevance of the eligible discussion to the target member account comprises:
identifying an updateable learned coefficient that corresponds with the match between the at least one predetermined member feature and the at least one predetermined discussion feature; and
calculating, for the respective eligible discussion, the relevance score based at least on the updateable learned coefficient.

6. The computer system of claim 5, wherein the at least one predetermined discussion feature comprises:
a discussion feature comprising at least one of: a number of times the respective eligible discussion has been viewed within a first time window, a number of comments on the respective eligible discussion, a number of times the respective eligible discussion has been viewed since it was initiated and an amount of likes the respective eligible discussion has received since it was initiated.

7. The computer system of claim 5, wherein the at least one predetermined discussion feature comprises:
an age discussion feature comprising an amount of time the respective eligible discussion has been active on the social network.

8. The computer system of claim 5, wherein the at least one predetermined discussion feature comprises:
an author feature comprising at least one of: a total amount of times an author member account has received likes and a total amount of comments on all discussions initiated by the author member account.

9. The computer system of claim 5, wherein the updateable learned coefficient represents a learned weighting of importance of the match in calculating the relevance score.

10. A computer-implemented method comprising:
filtering a plurality of discussions in a social network to identify a discussion pool;
identifying a plurality of eligible discussions in the discussion pool, wherein each eligible discussion corresponds to a respective social network member group to which a target member account has previously subscribed;
calculating, via at least one processor, a relevance score for each eligible discussion, the relevance score predictive of a relevance of the eligible discussion to the target member account; and
recommending at least one of the eligible discussions to the target member account based at least in part on the calculated relevance scores.

11. The computer-implemented method of claim 10, wherein filtering a plurality of discussions in a social network to identify a discussion pool comprises:
identifying a set of discussions in the social network initiated during a first time range;
identifying at least one ineligible discussion in the set of discussions based on the at least one ineligible discussion containing promotional content; and
disqualifying the at least one ineligible discussion from inclusion in the discussion pool.

12. The computer-implemented method of claim 10, wherein identifying a plurality of eligible discussions in the discussion pool comprises:
filtering the discussion pool according to at least one of: at least one discussion age criteria and at least one social network activity criteria; and
identifying each respective discussion in the discussion pool that satisfies the at least one discussion age criteria and the at least one social network activity criteria as a respective eligible discussion.

13. The computer-implemented method of claim 10, wherein calculating, for each eligible discussion, a relevance score predictive of a relevance of the eligible discussion to the target member account comprises:
identifying at least one predetermined member feature existing in a plurality of profile attributes of the target member account matches at least one predetermined discussion feature existing in a plurality of discussion attributes of the respective eligible discussion; and
calculating, for the respective eligible discussion, the relevance score based at least on a match between at least one predetermined member feature and the at least one predetermined discussion feature.

14. The computer system of claim 13, wherein calculating, for each eligible discussion, a relevance score predictive of a relevance of the eligible discussion to the target member account comprises:
identifying an updateable learned coefficient that corresponds with the match between the at least one predetermined member feature and the at least one predetermined discussion feature; and
calculating, for the respective eligible discussion, the relevance score based at least on the updateable learned coefficient.

15. The computer-implemented method of claim 14, wherein the at least one predetermined discussion feature comprises:
a discussion feature comprising at least one of: a number of times the respective eligible discussion has been viewed within a first time window, a number of comments on the respective eligible discussion, a number of times the respective eligible discussion has been viewed since it was initiated and an amount of likes the respective eligible discussion has received since it was initiated.

16. The computer-implemented method of claim 14, wherein the updateable learned coefficient represents a learned weighting of importance of the match in calculating the relevance score.

17. A non-transitory computer-readable medium storing executable instructions thereon, which, when executed by a processor, cause the processor to perform operations including:
filtering a plurality of discussions in a social network to identify a discussion pool;
identifying a plurality of eligible discussions in the discussion pool, wherein each eligible discussion corresponds to a respective social network member group to which a target member account has previously subscribed;
calculating, for each eligible discussion, a relevance score predictive of a relevance of the eligible discussion to the target member account; and
recommending at least one of the eligible discussions to the target member account based at least in part on the calculated relevance scores.

18. The non-transitory computer-readable medium of claim 17, wherein filtering a plurality of discussions in a social network to identify a discussion pool comprises:
identifying a set of discussions in the social network initiated during a first time range;
identifying at least one ineligible discussion in the set of discussions based on the at least one ineligible discussion containing promotional content; and
disqualifying the at least one ineligible discussion from inclusion in the discussion pool.

19. The non-transitory computer-readable medium of claim 17, wherein identifying a plurality of eligible discussions in the discussion pool comprises:
filtering the discussion pool according to at least one of: at least one discussion age criteria and at least one social network activity criteria; and
identifying each respective discussion in the discussion pool that satisfies the at least one discussion age criteria and the at least one social network activity criteria as a respective eligible discussion.

20. The non-transitory computer-readable medium of claim 17, wherein calculating, for each eligible discussion, a relevance score predictive of a relevance of the eligible discussion to the target member account comprises:
identifying at least one predetermined member feature existing in a plurality of profile attributes of the target member account matches at least one predetermined discussion feature existing in a plurality of discussion attributes of the respective eligible discussion; and
calculating, for the respective eligible discussion, the relevance score based at least on the a match at least one predetermined member feature and the at least one predetermined discussion feature.
